(19) United States
(12) Patent Application Publication
(10) Pub. No.: US 2014/0115506 A1
(43) Pub. Date: Apr. 24, 2014

(54) Systems And Methods For Measurement Of User Interface Actions

(71) Applicants: William Brandon George, Pleasant Grove, UT (US); Kevin G. Smith, Lehi, UT (US)

(72) Inventors: William Brandon George, Pleasant Grove, UT (US); Kevin G. Smith, Lehi, UT (US)

(21) Appl. No.: 13/408,961

(22) Filed: Feb. 29, 2012

(51) Int. Cl. G06F 3/048

(52) U.S. Cl. 715/764

(57) ABSTRACT

An application is implemented with user interface (UI) action capture code. The UI action capture code is configured to capture information identifying one or more user interface actions within the same view of the application interface. During execution of the application, information associated with one or more UI actions within the same view of the application interface is captured with the UI action capture code. In some embodiments, one or more records comprising said information identifying said one or more UI actions captured by the UI action capture code are stored or transmitted. In some embodiments, UI action records comprising information captured during use of respective instances of an application on a plurality of remote computing devices are received from the plurality of remote computing devices. The UI action information for the same view of the application is aggregated and analyzed.

### BACKGROUND

Computing devices have become widely available in recent years. Examples of computing devices are laptops, tablets, smart phones and gaming consoles. Typically a wide variety of software and/or applications are implemented on the computing devices. The software and/or applications may be word processing, mail tools, image processing tools, games and/or web-based browsers. The computing devices may implement a user interface to facilitate user interaction with the applications implemented on the computing device. The user interface may accept mouse operations, touch screen operations, accelerometer changes and/or keystrokes to initiate an event in the software or application on a computing device. For example, a smart phone may accept touch screen operations to activate a feature of an application, select an object and/or enter data within the same view of the application. As another example, in a web-based browser executing on a tablet or desktop computing device, a user interface may accept mouse operations or touch screen operations in the same view of the application to select an item for purchase, zoom in for a closer view, select features of the item (e.g., color) and put the item in a shopping cart. As another example, a mouse click may be used on a laptop to select a menu option in an image processing application. Within the same view of the image processing application, the selected menu option enables features of the image processing application that allow the user interface to accept mouse operations, touch screen operations or keystrokes to edit or move an object within the same view of the application.

Users of an application may interact with the application in ways described above (e.g., mouse clicks, etc.). A user may interact with the application in many combinations of user interface actions within the same view of the application. During a session of the application some of the user interface actions may not complete as the developer of the application intended. For example, a user of an image processing tool may have to execute nine separate user interface actions to achieve a particular task. As another example, a user of an application (e.g., “app”) on a mobile device may select certain options repeatedly without success and exit the application. As another example, a user of an application such as a word processing tool may select a task and the select “undo” as the next action. As a further example, a tablet user may touch an image within a webpage they are viewing several times expecting the image to zoom to a larger size and then exit because they aren't able to view the image as intended.

When the user attempts any of the above actions and does not receive the expected result or encounters issues, the user may become frustrated. This may degrade the overall user experience.

### SUMMARY

Various embodiments of methods and systems for measuring user interface actions are presented. In some embodiments, a method for measuring user interface actions includes executing an application and user interface (UI) action capture code. In some embodiments, UI action capture code is configured to capture information identifying a sequence of one or more user interface actions within the same view of the application interface. During execution of the application, some embodiments capture with the UI action capture code information identifying the sequence of one or more user interface actions within the same view of the application interface. Some embodiments further include storing or transmitting one or more records comprising said information identifying the sequence of one or more user interface actions and the context of user interface actions captured by the UI action capture code.

In some embodiments, the method described above is performed by code added to the application, device or platform for which it is desired to monitor and capture user interface actions. In some embodiments, program instructions stored on a non-transitory computer readable storage medium or memory where the program instructions are executable by a computing device or processor are implemented to carry out the described method.

In some embodiments, a method and system for aggregating and reporting user interface actions is implemented. Some embodiments include receiving, from a plurality of remote computing devices, user interface action records comprising information captured during use of respective instances of an application on the plurality of remote computing devices. Some embodiments include aggregating the information from the user interface action records for the same view of the same application, and analyzing said aggregated information from the user interface action records for the same view of the same application according to one or more criteria.

### BRIEF DESCRIPTION OF THE DRAWINGS

FIG. 1 illustrates an exemplary configuration that supports measuring user interface actions in accordance with one or more embodiments of the present technique.

FIG. 2 depicts an exemplary hierarchy for measuring user interface actions in accordance with one or more embodiments of the present technique.

FIG. 3 is a flowchart of the user interface (UI) action capture code mechanism in accordance with an embodiment of the present technique.

FIG. 4 is a flowchart of an exemplary method for measuring user interface actions in accordance with an embodiment of the present technique.

FIG. 5 is a flowchart of an exemplary method for analyzing user interface actions, in accordance with one or more embodiments of the present technique.

FIGS. 6A-C are tables depicting an exemplary set of reports in accordance with an embodiment of the present technique.

FIG. 7 illustrates an exemplary computer system in accordance with one or more embodiments of the present technique.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Headings used herein are for organizational purposes only and are not meant to be used to limit the scope of the description.

### DETAILED DESCRIPTION OF EMBODIMENTS

As discussed in more detail below, provided in some embodiments are systems and methods for measuring user interface actions. In some embodiments, user interface (UI) action capture code is configured to execute with an application. The UI action capture code, in some embodiments, is configured to capture information identifying a sequence of one or more user interface actions within the same view of the application interface. In some embodiments a user interface action is captured by the UI action capture code. In addition, in some embodiments, the captured user interface actions are stored or transmitted. In some embodiments, the captured information corresponding to the user interface actions include a user interface action type and/or context. The user interface action type may indicate the type of action, such as mouse click, touch gesture, keyboard key combination, etc, for example. In some embodiments, the user interface action is one or more user interface actions executed in a sequence. The user interface action context may be reported as coordinates within a view of the application and/or in terms of the user interface element for the event, for example.

In addition, in some embodiments, the recorded information is transmitted to a data collection server that aggregates recorded information received from multiple independent instances of the application. The recorded information corresponding to the user interface actions is aggregated to analyze user interface actions for the same view of the same application. In some embodiments, the aggregated information is analyzed to determine checkpoints of interest and chains associated with the checkpoints of interest. In some embodiments, a report may be generated for the analyzed data.

For example, in some embodiments, a user of an image processing application on a laptop may use the cropping feature. The feature may not be well implemented and the user may have difficulty determining which side of the image will be cropped. So the user may have to frequently utilize the “undo” function to backtrack from unintended results. In addition, the cropping feature may be implemented such that only one side of the object can be adjusted at one time. This may result in further need for the user to execute an “undo” function to achieve the desired results. Unknown to the user, though, UI action code executing with the image processing application captures the user interface event (e.g., cropping feature and “undo” function) and transmits it to a log and/or data collection center. Based on the frequency of independent users of the application requiring the “undo” function or having to execute a multitude of steps to achieve a desired result, the developer of the image processing application may implement short cuts or other modifications to the cropping feature.

In another example embodiment, a tablet user may execute an “app” (e.g., literature reading, gaming, or other entertainment application). Users of this “app” may frequently access the help information for the “app”. For example, a user may look through menu options and then select a help request option. As another example, an object may be selected, dragged and another option selected prior to accessing the help request option. As another example, a user may review the FAQ page and then select the “contact us” or “report an error” option. Based on the information provided by the UI action code capturing the sequence of actions and the context of the actions preceding the help request, the developer may determine opportunities to modify the “app” and improve the user experience.

In another example embodiment, a mobile device or tablet user may execute an “app” such as a stock quote app. The information captured by the UI action capture code may indicate that a majority of users pinch on the chart to zoom in and reduce the calendar range, then swipe or pan right, zoom one more time, pan two more times, etc. This information captured by the UI action capture code may indicate that the default view should be a smaller date range or that the user needs more options to adjust the date range.

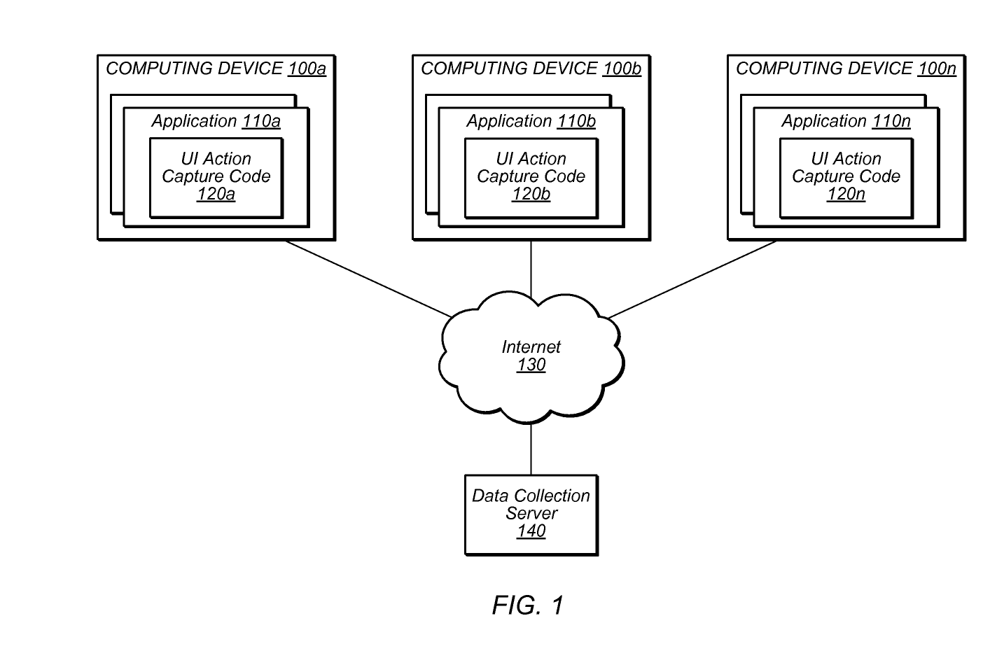

FIG. 1 illustrates an exemplary configuration that supports measuring user interface actions in accordance with one or more embodiments of the present technique. In general, a computing device 100 may be any type of computing device, such as a laptop and/or personal computer, a smart phone, a tablet, television, set-top box, and/or a gaming console, for example. In some embodiments, each computing device 100 implements one or more applications 110 that are operable to receive user interface actions from the user interface coupled to the computing device. Examples of application 110 are one or more web pages viewable from a web-based browser, a word processing application, an “app” (e.g., game or other tool available on mobile devices) and/or an image processing application. A user interface action at the user interface may be, for example, a user clicking a mouse, a user touching a screen, a movement of the device, and/or a user pressing a key on a keyboard. In some embodiments, a user interface action at the user interface may select features or options of the application. For example, Ctrl-z may select an undo option, a swipe on a screen may scroll within the view of the application or a mouse click may select a menu option. In other embodiments, a user interface action may be a composite of one or more user interface actions. For example, the “crop” feature of an application may include selecting the object to crop, selecting the “crop” feature and indicating the area to crop.

In some embodiments, UI action capture code 120 is installed, plugged-in, or otherwise implemented within application 110 to capture all actions or actions of interest that occur within a single view of an application. The user interface action captured with UI action capture code 120 is reported from each independent instance of application 110 on computing device 100 to data collection server 140, in some embodiments. In some embodiments, data collection server 140 is configured to receive recorded information reflecting user interface actions in each independent instance of application 110 on each computing device 100. In some embodiments, data collection server 140 aggregates and analyzes the captured information to generate a report corresponding to checkpoints of user interface actions of interest within the same view of the application. This will be described in further detail below.

Computing device 100 may be a tablet computer, mobile phone, smart phone, personal computer, gaming console and/or other processor based device configured to receive user interface actions, for example. In some embodiments, each computing device 100 has a user interface configured to receive the user interface action. Examples of a user interface, not explicitly shown, are keyboards, mouse, interactive screens and/or accelerometers configured to determine changes in movement of computing device 100. In some embodiments, each computing device has an operating system (OS), not explicitly shown, configured implement one or more applications 110. In some embodiments the OS (e.g., WINDOWS™, MAC OSX™, APPLE IOS™, ANDROID™, etc.) native to each computing device may be configured to receive one or more user interface actions at one or more user interfaces and pass the user action to one or more corresponding applications 110.

In some embodiments, application 110 may be software configured to execute within the OS environment of computing device 100. Examples of application 110 are a web-based browser configured to display web pages, an image processing application, a word processing application, a calendar tool, a mail tool and/or entertainment “app” (e.g., “apps” for mobile devices). Application 110, in some embodiments, includes content that responds to user interface actions (e.g., interactive content), such as web pages, games, videos, etc. In some embodiments, UI action capture code configured to receive user interface actions from the OS and/or user interface of computing device 100 is implemented in each application 110 on computing device 100. The UI action capture code may receive user interface actions such as a one or more single mouse clicks, a double mouse click, a mouse over, a mouse drag, a screen touch, a screen pinch, a scroll, a key press, key combinations, swipes, zooms, rotations, general movement or free-form gestures (e.g., Kinect™ movement events), and/or voice activation, for example. In some embodiments, the UI action capture code captures a composite of user interface actions. For example, the UI action capture code may receive an “add note” user interface action as a button selection or click. However, the “add note” feature comprises selecting “add note”, typing text and selecting “ok”. In some embodiments, this is received as a single user interface action. In some embodiments, each user interface action causes a corresponding response within application 110. However, for example, there may be one or more user interface actions that frequently occur and indicate opportunities to improve application 110.

In some embodiments, UI action capture code 120 implemented internal and/or external to application 110 captures user interface actions within the same view of application 110. For example, UI action capture code 120 may be implemented to execute with application 110 to capture all user interface actions or user interface actions within the same view of application 110. UI action capture code 120 may be configured as embedded code within application 110, as a plug-in and/or a component (e.g., error handler) within application 110, for example.

In some embodiments, UI action capture code 120 records and/or transmit information corresponding to user interface actions received within the same view of the application to data collection server 140. As depicted in FIG. 1, some embodiments include one or more computing devices 100 with one or more applications 110 including one or more UI action capture code 120. Accordingly, in some embodiments, information corresponding to user interface actions received by the application is recorded and/or transmitted to data collection server 140 for multiple instances of the application. The information corresponding to user interface actions may also include additional data, such as identifiers for each computing device and/or instance of the application or time stamps for each user interface action, for example. In some embodiments, data collection server 140 aggregates the data for each application and determines the frequency of a given user interface action within the same view of application 110, for example. In some embodiments, data collection server 140 aggregates data for the user interface action in each instance of application 110 to a sequence of user interface actions or user interface actions preceding a user interface action of interest. The reports generated from data collection server 140 may provide, for example, an application developer with data used to determine development opportunities for the next release of application 110.

For example, the view for an application in a smart phone may offer many options for interaction via user actions. A developer of an entertainment “app” may wish to track commonly repeated user interface actions to determine if a feature of an “app” needs improvement. For example, an “app” for city maps may be configured to receive user interface actions in the form of voice commands. The developer may track the voice command and note that given cities are repeated multiple times. For example, the “app” may have difficulty in distinguishing between “Austin” and “Boston” among other cities. The information captured by the UI action capture code for each instance of the “app” and transmitted to the data collection server may indicate that the most frequent repetitive user action is repeating the city for the desired map. With this information, the developer may decide to refine the voice recognition portion of the “app” and release a new version of the “app”.

As another example, in an image processing tool application executing on a laptop or desktop computing device, the developer may be interested in the position of a user action within a sequence of user actions. To continue the cropping example above, the aggregated data from the multiple instances of the application, may show that users most frequently crop three of the four possible sides of an image and then execute an undo command, a delete command or other option for the image, for example. By noting with the information captured by the UI action capture code that the user most frequently encounters issues after completing three of the four crop steps, the developer may modify the crop feature of the image processing tool.

As another example, an “app” on a mobile device may be an entertainment “app” such as a game. The UI action capture code may capture and transmit all user interface action to the data collection server. The aggregated data for each instance of the “app” may show that the user interface action sequence A to B to C to D is the most frequent user action sequence. Knowing the most frequently executed user interface actions may indicate the most popular portions of the “app” or game. Knowing this information may lead the developer to enhance the popular portion of the game.

In some embodiments, page/view pathing can be combined with UI action pathing to also provide insight to the developer/marketer. For example, a report could show a marketer the following: Page A>UI Action B>UI Action C>Page D>UI Action G. Although some embodiments do not require such combinations, embodiments supporting such combinations may be leveraged at times to provide additional insight to the developer/marketer. A retail website, for example, may track a user's path as they move from each product page and also capture the user experience within each view of the website (e.g., product page). The UI action capture code may capture and transmit all user interface actions in addition to the page view information to the data collection server. The data may indicate that eighty percent of the users scroll through the product review section. The data may also indicate that many users leave the product page after attempting to view the product details or zoom in on the product picture. Knowing this information may cause the developer or marketer to improve or change the product pages.

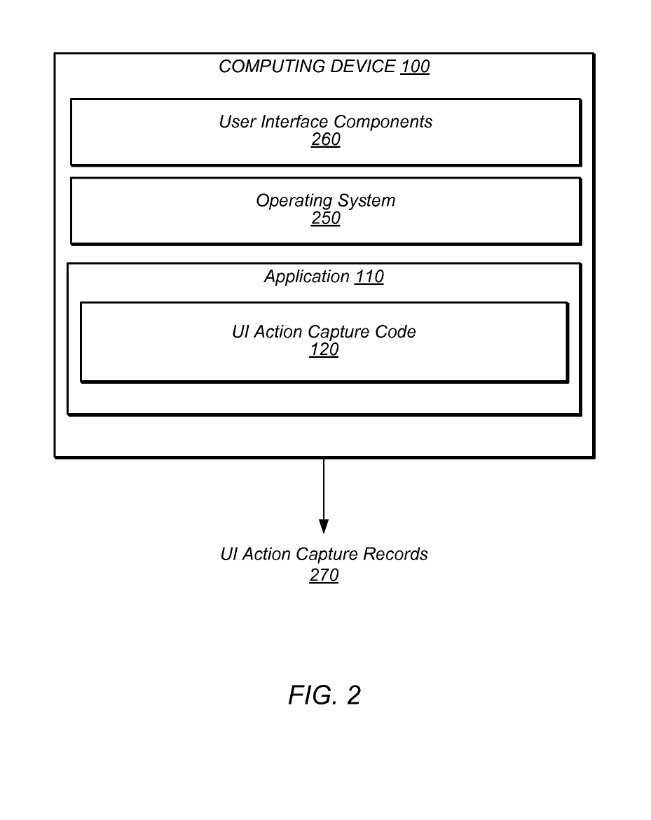

FIG. 2 depicts an exemplary hierarchy for measuring unsupported events in accordance with one or more embodiments of the present technique. In general a computing device (e.g., computing device 100 in FIG. 1) has an operating system 250 configured to accept and/or disposition user interface actions from user interface components 260 to application 110. As discussed above in FIG. 1, user interface actions are received from a mouse, keyboard, touch screen, movement and/or voice activation, for example. The OS 250 (e.g., WINDOWS™, MAC OSX™, ANDROID™, APPLE IOS™, etc.) may support one or more applications 110, for example. In some embodiments, to capture information about user interface actions received by the application, UI action capture code 120 is added or otherwise provided at one or more points within application 110. For example, UI action capture code 120 may be implemented as code embedded within the application, as a plug-in to run in conjunction with the application, as tags or variables within the application code or other method configured to capture user interface actions. In some embodiments, the information received in the UI action capture code 120 is recorded and/or transmitted in UI action capture records 270.

Computing device 100, as described above in FIG. 1, may be a tablet, smart phone, gaming device, laptop and/or desktop computer, for example. In some embodiments, each computing device 100 has user interface components 260, operating system 250 and/or one or more applications 110 implemented. As discussed above operating system 250 may be WINDOWS™, MAC OSX™, APPLE IOS™ and/or ANDROID™, for example. In some embodiments, each operating system is configured to receive user interface actions from the user interface components 260. Examples of user interface components 260 are keyboards, mouse, interactive screens, voice recognition and/or accelerometers or other motion sensors configured to determine changes in movement of computing device 100 or users. Examples of user interface actions are mouse clicks, screen touches, movements, voice activation and/or key presses.

Application 110 may be any software configured to execute within the OS of computing device 100, for example. Application 110 may include, but is not limited to, a word processing tool, an image processing tool, a mail tool, a game and/or an “app” on a smart phone and/or tablet, for example. In some embodiments, application 110 is configured to receive user interface actions from the operating system. As discussed above, the OS receives the user interface actions from user interface components 260. In some embodiments, application 110 comprises mechanisms, not explicitly shown, to handle the received user interface actions. As discussed above, user interface actions may be mouse clicks, screen touches, movements, voice activation and/or key presses, for example.

In some embodiments, UI action capture code 120 is implemented to capture all or a portion of user interface actions and information associated with the user interface actions. UI action capture code 120 is implemented by embedding the code within the application, executing a plug-in module in conjunction with an application, tags or variables embedded in the code, error handlers or other code configured to track user interface actions, for example. In addition to capturing user interface actions, in some embodiments, UI action capture code 120 captures information associated with the user interface action. In some embodiments, each user interface action has context. For example, the UI action capture code may capture a user interface action selecting an object and then a menu option in an image processing tool (e.g., crop, paste, rotate etc). In addition to the user interface action, the context of the two user interface actions may be captured in some embodiments. The UI action capture code may capture that the method for selecting the object and the menu option was a mouse click, for example. In addition, for example, the coordinates of the object may be captured or the time between mouse clicks. Other examples of context are the number of mouse clicks (e.g., single click event, double click event, etc.) and/or a unique identifier related to the independent instance of the application (e.g. application 110b) and/or computing device (e.g., computing device 100). In some embodiments, the records with the information captured by the UI action capture code are sent to a log for the application developer and/or a data collection server (e.g., data collection server 140 in FIG. 1).

As an example, a developer of a new “app” (e.g., application 110 in FIG. 2) for a smart phone or tablet computing device (e.g., computing device 100 in FIG. 2) may embed UI action capture code (e.g., UI action capture code 120 in FIG. 2) in the “app” to track all user interface actions in the same view of the “app”. The captured user interface actions and the information associated with the user interface actions may be transmitted in records (e.g., UI Action Capture records 270 in FIG. 2) to a data collection server. The records may include user interface actions and the context for the user interface action (e.g., unique identifier for each instance of the app, coordinates, time stamps, etc.) The developer may aggregate the information and then analyze the information to determine aspects of the user experience. For example, the report may indicate the most popular sequence of user interface actions, the most/least frequent user interface action, the sequence of user interface actions prior to an error/help action or length of time between user interface actions. The developer may use the results of the analysis to determine the next opportunities for enhancement or development of the “app” from the results aggregated from the information in the UI action capture records.

As another general example, the application developer may only be interested in the user experience with newly implemented features. The developer may include code, tags, variables etc in the application (e.g., application 110 in FIG. 2) that capture the user interface actions associated with the newly implemented features. Based on this information, the developer may learn more about the user experience. For example, the developer may determine that the composite of user interface actions that comprise the new features is accessed by forty percent of application users. In addition, the developer may determine from the user interface action information that sixty percent of the users exit the new feature prior to completing the task. As another example, the developer may learn that the 6^{th} action in the sequence of user interface actions associated with the feature corresponds to an unusually high number of accesses to “undo” or “help” features. This information may determine modifications for the new feature in the application, for example.

As another example, a game application (e.g., application 110 in FIG. 2) for a mobile computing device (e.g., computing device 100) may capture all user interface actions (e.g., UI action capture code 120 in FIG. 2) for a view of the game application. User interface actions for a game application on a mobile computing device may be swipes, drag/drop motions, one or more taps, pinches and/or reverse pinches. An example game may be a children's game with vehicles that have to be moved from one track to another by matching numbers of the track and vehicles. In the game a typical user interface action may be to drag and drop the vehicle from one track to another. Another typical action may be to tap a vehicle to stop and/or stop the vehicle motion to avoid crashes. Based on the information captured from user interface actions (e.g., UI Action capture records 270), the developer may learn that a particular track for the vehicles is not chosen very often by the random algorithm implemented to launch the vehicles. The developer may learn that a particular percentage of users have to tap more than once to start/stop a vehicle motion. The developer may learn that a certain percentage of the users miss moving vehicles in motion to the appropriate track in the given amount of time. Based on this information, the developer may decide to offer multiple levels of the game so that users with different skill levels can enjoy the game at the appropriate speed. The developer may augment the algorithm for the vehicle launches to ensure a more randomized approach. Lastly, the developer may increase the size of the vehicles so that it is easier to stop/start the vehicles with the first tap.

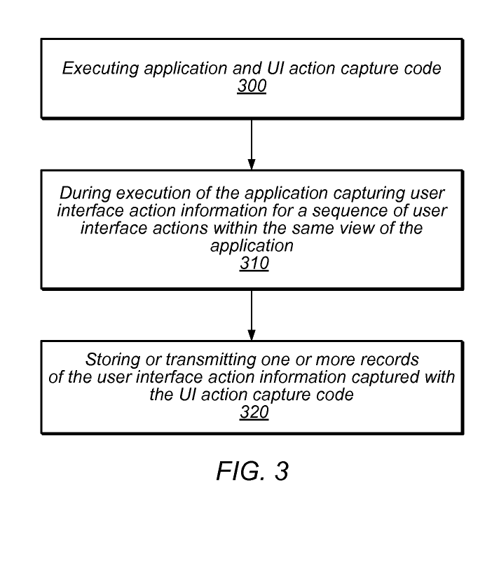

FIG. 3 is a flowchart of the user interface (UI) action capture code mechanism in accordance with an embodiment of the present technique. As discussed above, UI action capture code captures user interface actions for an application. As discussed above in FIG. 2, the UI action capture code may be embedded in the application code, may be implemented as tags/variables within the code and/or implemented in an error handling code for example. In general, for example, the UI action capture code executes with the application and captures the user interface actions and the information associated with user interface actions as they occur and often in the sequence they occur. As discussed above, user interface actions may be, for example, mouse clicks, keystrokes, screen touches and/or voice activation received from a user interface component (e.g., user interface components 260 in FIG. 2). In some embodiments, the UI action capture code captures a user interface action that is a composite of one or more user interface actions in addition to the independent user interface actions. For example, as described above, an “add note” feature may comprise three user interface actions such as selecting the “add note” feature, typing text and selecting “ok”. In some embodiments, all of the user interface actions are captured and stored or transmitted via records (e.g., UI action interface records 270 in FIG. 2)

As indicated in 300, in some embodiments, the application and the UI action capture code executes concurrently. As discussed above, the application and UI action capture code may be software that executes on a computing device (e.g., application 110 and computing device 100 in FIG. 1). For example, a computing device may be, but is not limited to, a smart phone, tablet, laptop, gaming console or a desktop computer. An application may be, but is not limited to, an image processing tool, social media software, games, word processing tools, mail tools, “apps” (e.g., mobile device applications) or web-based browsers. As discussed above, in some embodiments, the UI action capture code (e.g., UI action capture code 120 in FIG. 1) executes with the application in order to capture the user interface actions and information associated with the user interface actions as they occur. An example of a user interface action and information associated with the user interface actions is a mouse click, the coordinates of the mouse click and the time stamp of the mouse click.

As indicated in 310, in some embodiments, during execution of the application the UI action capture code captures user interface action information for a sequence of user interface actions within the same view of the application (e.g., application 110 in FIG. 1). The UI action capture code captures all user interface actions or in alternate embodiments only user interface actions of interest. As discussed above, UI action capture code is implemented as, but is not limited to, code embedded in the application, tags/variables associated with the application code, a plug-in or an error handler, for example. As discussed above, in some embodiments, the UI action capture code (e.g., UI action capture code 120 in FIG. 1) captures user interface actions and the context of the user interface action. Examples of user interface actions are mouse clicks, keystrokes, screen touches and/or voice activation. In some embodiments, user interface actions may be a composite of one or more user interface actions. For example, in a calendar application “add an event” comprises typing event information, selecting notification preferences and selecting “done”. The application and UI action capture code receive the user interface actions from the user interface components (e.g., user interface components 260 in FIG. 2) as passed through the operating system of the computing device (e.g., computing device 100 and operating system 250 in FIG. 2). For example, an image processing application with UI action capture code embedded in it may execute on a desktop computer. The UI action capture code may record a mouse click to select an object. The next mouse click may select a menu option such as rotate, crop or copy, for example. In addition, the UI action capture code may record the context of the user interface actions. For example, the context may be, but is not limited to, a unique application instance or user ID, time stamps of the user interface actions, type of user interface action and/or coordinates of the user interface actions within the same view of the application.

As another example, the application may be an “app” on a smart phone or a tablet computing device (e.g., computing device 100 in FIG. 2). The “app” (e.g., application 110 in FIG. 1) may be an application for monitoring stocks on the New York Stock Exchange. The “app” allows users to enter a ticker symbol, view the performance over a date range, choose multiple indexes to track and scroll through news headlines. The UI action capture code may capture, within the same view of the “app”, screen touches (e.g., taps) to select a feature, motion (e.g., swipes) to scroll through the headlines, pinches to zoom in and reverse pinches to zoom out. In addition, the UI action capture code may capture the sequence of user interface action, time stamps of the user interface actions or the ticker symbols entered.

As indicated in 320, in some embodiments, the records comprising the information associated with the user interface actions and the user interface actions context are stored or transmitted. The stored or transmitted information may subsequently be aggregated across multiple users for the same view of the application. The information may be stored locally in logs for subsequent analysis or may be transmitted to a collection server. This will be discussed in greater detail below.

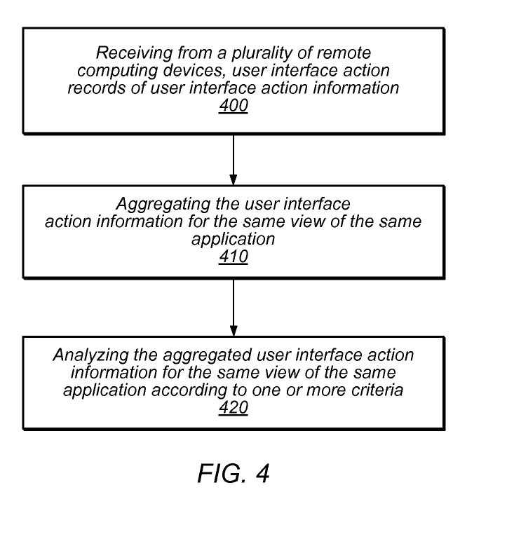

FIG. 4 is a flowchart of an exemplary method for measuring user interface actions in accordance with an embodiment of the present technique. As discussed above, the UI action capture code (e.g., UI action capture code 120 in FIG. 2) captures user interface actions that occur while an application is executing. In some embodiments, the information (e.g., the user interface action and the context of the user interface action) captured by the UI action capture code is transmitted or stored as described in FIG. 3. In general, for example, the stored or transmitted information may be received from a plurality of remote computing devices. Each remote computing device may have a unique ID, for example. The user interface action information may be aggregated for the same view of an application. In addition, the aggregated user interface action information is analyzed according to one or more criteria. For example, the aggregated user interface action information may be analyzed to determine the most frequently accessed feature or the last user action performed before the application was exited.

As indicated in 400, in some embodiments, user interface action records of user interface action information are received. As discussed above, the user interface action information may include user interface actions (e.g., mouse clicks, screen touches, etc.) received from user interface components (e.g., user interface components 260 in FIG. 2). In some embodiments, the user interface action information may also include context information associated with the user interface action. For example, mouse clicks to select an object may have location coordinates associated with it. As another example, double taps to select and zoom in on an object may have location coordinates associated with it. As another example, time stamps for each user interface action may be captured.

As indicated in 410, in some embodiments, the user interface action information for the same view of the same application is aggregated. For example, an application may have one or more views associated with it or a computing device may transmit records for multiple applications. For example, a computing device (e.g., computing device 100 in FIG. 1) may have multiple “apps” (e.g., application 110 in FIG. 1) installed on the computing device. Each time an individual “app” is accessed, the UI action capture code (e.g., UI action capture code 120 in FIG. 2) captures and transmits user action information in records (e.g., UI action capture records 270 in FIG. 2), for example. As another example, a game on a mobile computing device, a laptop or a desktop computing device may have multiple levels of the game that are displayed in separate views. User interface action information may be aggregated for each view of the game.

As indicated in 420, in some embodiments, the aggregated user interface action information for the same view of the same application is analyzed according to one or more criteria. In some embodiments, all of the user interface action information is included in the aggregated user interface action information. In some embodiments, one or more criteria may be used in the analysis. For example, a developer may wish to know the most popular sequences executed in an application. As another example, the sequence of actions leading to an undo operation or access to help information may provide insight into improvements needed on the view of the application. As another example, the most frequent user interface action may be a double tap or a reverse pinch on an image within the view. This may indicate that users of the application wish to zoom in on the image because the image is currently too small. As another example, analysis of the sequence of user interface actions in the stock quote app described above may indicate that a high percentage of the users adjust the range of the display after entering their stock quote choices. This may indicate that a particular range is difficult to view. As another example, the user action information for the same view of an application may indicate that the crop function of the image processing tool described above needs improvement. The analysis of the information may indicate that users execute nine steps to crop an object and then a given percentage of the users execute an undo or delete function. Further details of analysis are discussed below.

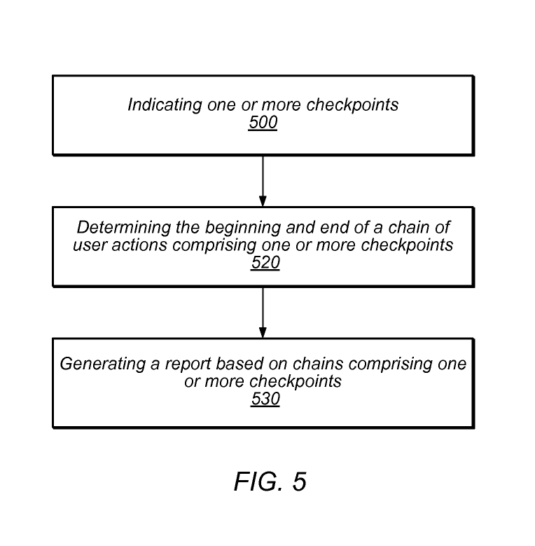

FIG. 5 is a flowchart of an exemplary method for analyzing user interface actions, in accordance with one or more embodiments of the present technique. For example, as discussed above, user interface action information (e.g., UI action capture records 270 in FIG. 2) transmitted or stored may include all the user interface actions captured within the same view of an application. In addition, there may be user interface action records received from a plurality of remote computing devices (e.g., as described in FIG. 4). In some embodiments, to analyze the user interface action information, one or more checkpoints are determined. For example, the checkpoints may be a particular feature accessed by a user interface action or two user interface actions events bounding a sequence of actions. In the analysis of the information, for example, a chain of user interface actions corresponding with one or more checkpoints may be determined and presented in a report.

As indicated in 500, in some embodiments, one or more checkpoints are indicated. For example, the one or more checkpoints may be, but are not limited to, user interface actions associated with a particular feature, the user action that occurs tenth in a sequence or two user interface actions bounding a sequence of user interface actions. As an example, the checkpoint may be the user interface action (e.g., mouse click, screen touch) selecting an exit from the application. As another example, two checkpoints may be chosen so that the attrition rate of the user for each user interface action between two particular user interface actions may be determined.

As indicated in 510, in some embodiments, once the one or more checkpoints have been indicated, the beginning and end of a chain of user interface action comprising the one or more checkpoints is determined. For example, if the checkpoint is the user interface action that selects an “undo” option determining the beginning and end of a chain may include identifying the “undo” as the checkpoint at the end of the chain. The beginning of the chain may be the user interface action that selected the object associated with the “undo” function. As another example, to determine the tenth user interface action in a sequence, the beginning of the chain may be the first user interface action captured and the end of the chain may be the tenth user interface action captured. As another example, as discussed above, the checkpoints may be two particular user interface actions that bound a sequence of user interface actions. The percentage of users who select each user interface action between the checkpoints may be captured.

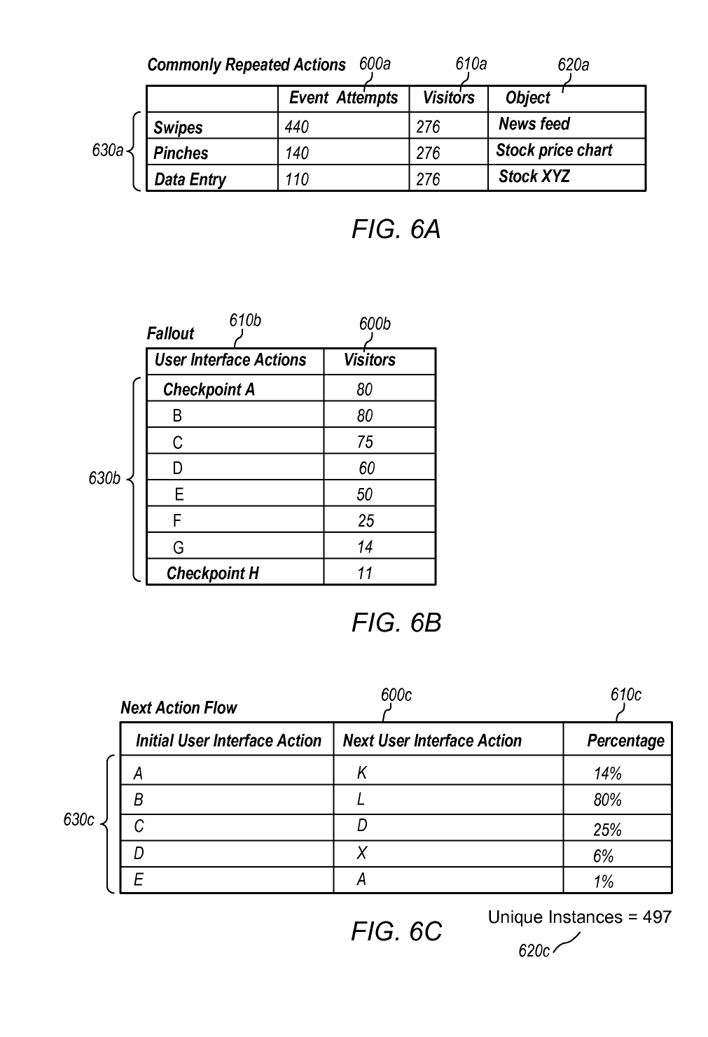

As indicated in 530, in some embodiments, a report based on the chains comprising one or more checkpoints may be generated. The data for the checkpoints described above, may be gathered and displayed in a report, for example. FIGS. 6A-C illustrates examples of reports. In other embodiments, the reports are displayed in another format. In some embodiments, the process depicted in FIG. 5 is performed by a data collection server receiving user interface action records (e.g., UI action capture records 270 in FIG. 2) from various remote devices (e.g., computing device 100 in FIG. 1) over one or more networks.

FIGS. 6A-C are tables depicting an exemplary set of reports in accordance with an embodiment of the present technique. In general, as discussed in previous figures, one or more computing devices (e.g., computing device 100 in FIG. 1) may implement instances of an application (e.g. application 110 in FIG. 1), for example. In some embodiments, the UI action capture code (e.g., UI action capture code 120 in FIG. 1) is implemented for the application, as discussed above, to capture user interface action and the context of the user interface actions for the same view of an application. As user interface actions are captured, for example, the user action (e.g. click, swipe) and the context (e.g., coordinated, user identifier) may be captured and/or transmitted to a data collection server (e.g., data collection server 140 in FIG. 1). In some embodiments, the data collection server aggregates and analyzes the user interface action information into reports or tables that check points of interest within the same view of an application. FIGS. 6A-C show example reports that may be generated in response to information (e.g., UI action capture records 270 in FIG. 2) received from instances of an application (e.g., application 110 in FIG. 1) on a computing device (e.g. computing device 100 in FIG. 1).

As depicted in FIG. 6A, the commonly repeated user interface actions were aggregated and analyzed for the same view of an application. Three user interface actions 630a (e.g., swipes, pinches, data entry) were reported for the stock quote “app” described above. This table may represent the user experience with a stock quote application for a smart phone and/or tablet computing device, for example. The user interface action information for 276 (e.g., 610a) unique sessions of the stock quote “app” may be aggregated and analyzed to determine the top three user interface actions. As indicated in 600a, swipes were the most commonly repeated action for the object newsfeed (e.g., 620a). A developer may decide to augment the newsfeed feature in response to determining that it is the most popular portion of the application (e.g., “app”). The second most commonly repeated user interface action (e.g., 600a) was the pinch user interface action (e.g., 630a) for the object stock price chart (e.g., 620a). This may indicate to the developer that the display of the stock price chart is sized incorrectly. The third most popular user interface action indicated (e.g., 600a) was the data entry (e.g., 630a) user interface action for object Stock XYZ (e.g., 620a). This may indicate to the developer that Stock XYZ is currently an indicator that many investors would like to follow so it may improve the user experience to include it along with default stock index in the view of the application.

As depicted in FIG. 6B, the fallout for user interface actions was aggregated and analyzed for the same view of an application. In the example view, the user interface actions were tracked between checkpoint A and checkpoint B (e.g. 630B). The fallout of visitors is represented in the second column 600b. This table may represent the user experience with a view of the application for a computing device (e.g. application 110 and computing device 100 in FIG. 1), for example. As described in FIG. 6A, there may be instances of an application on multiple computing devices. The column representing visitors 600b represents the number of unique sessions and/or visitors (e.g., users) attempting the swipe, rotation, tap and/or pinch, user interface actions 610b for example. The report in FIG. 6B indicates the number of users that continue along the segment from checkpoint A to checkpoint B (e.g., 630b). The attrition may be as expected when traversing Checkpoint A to user interface action E. However, the drop-off of half of the visitors between user interface action E and F (e.g., 610b) may indicate an issue that the developer may want to address. The data also indicates that there is another significant drop-off between user interface action F and G (e.g., 610b). Again this may be an opportunity for the developer to augment the application. It should be noted that checkpoints A and H may also be user interface actions. These actions act as the beginning and end of a chain of user interface actions.

In addition, other embodiments of the fallout report depicted in FIG. 6B may include the type of user interface action (e.g., mouse click, screen tap, etc.) that was used to execute the user interface action. The report may also include average time between each user interface action. Long gaps in time may indicate that a user is having difficultly determining a particular aspect of the application. The report may also include multiple chains of interest with a variety of checkpoints.

As depicted in FIG. 6C, a report was generated for the next action flow of the user interface actions in the same view of an application. In this view, five user interface actions 630c were tracked (e.g., keystrokes, mouse events etc). The table may represent the user experience with an image processing on a laptop, tablet and/or smart phone, for example. As described in FIGS. 6A and B, there may be multiple instances of an application (e.g., application 110 in FIGS. 1 and 2) on multiple computing devices (e.g., computing devices 100 in FIG. 1). The number of unique instances (e.g., 620c) included in this report may be indicated. The initial user interface action (e.g., 630c), the next user interface action (e.g., 600c) and the percentage of transitions (e.g., 610c) from the initial user interface action to the next user interface action may be reported. This type of report may be useful for a newly released application to determine the popularity of new features. In addition, this report may indicate a typical user workflow in the same view of an application. Other information that may be included in this type of report is type of user interface action, length of time between user interface actions, subsequent user interface actions or coordinates of the user interface actions, for example.

Although FIGS. 6A-6C depict various reports for various applications, other embodiments may alter the report format, the type of data, the length of the report or the amount of information included without departing from the teachings of the present technique.

### Exemplary Computer System

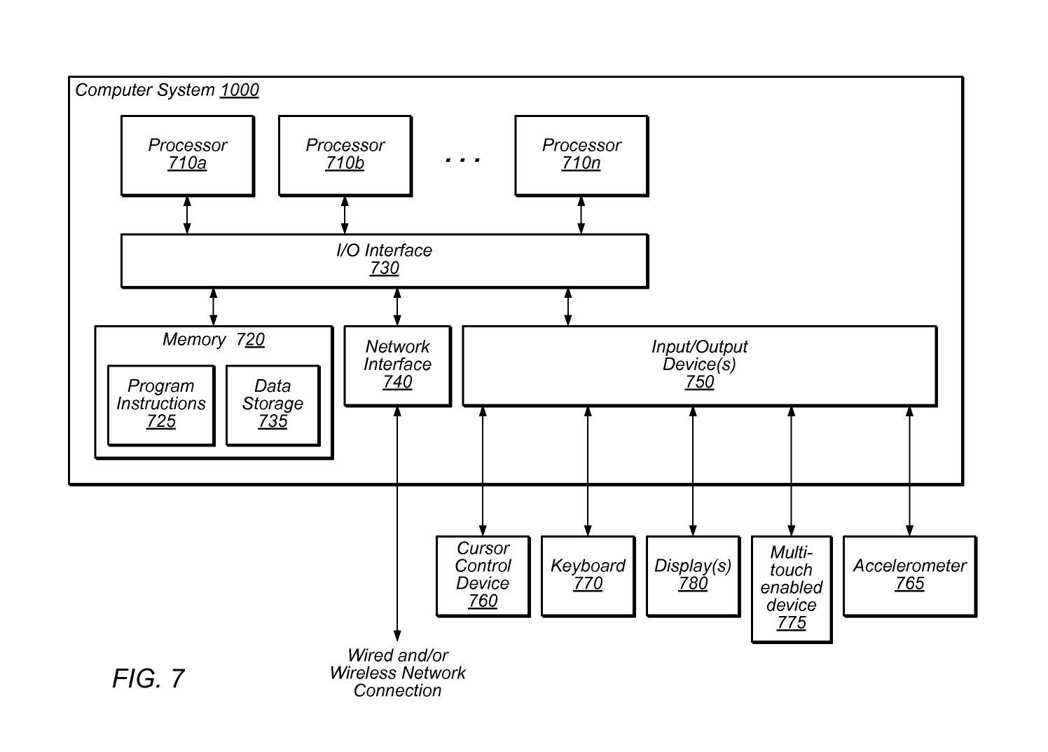

FIG. 7 is a diagram that illustrates an exemplary computer system 700 in accordance with one or more embodiments of the present technique. Various portions of systems 100 in FIGS. 1 and 2 and/or methods presented in FIGS. 3-6 and/or described herein, may be executed on one or more computer systems similar to that described herein, which may interact with various other devices of the system. For example, UI action capture code 120 may be executed on a processor in computing device 100. Data collection server 140 may include a computer similar to that of computer system 700.

In the illustrated embodiment, computer system 700 includes one or more processors 710 coupled to a system memory 720 via an input/output (I/O) interface 730. Computer system 700 further includes a network interface 740 coupled to I/O interface 730, and one or more input/output devices 750, such as cursor control device 760, keyboard 770, audio device 790, and display(s) 780. In some embodiments, it is contemplated that embodiments may be implemented using a single instance of computer system 700, while in other embodiments multiple such systems, or multiple nodes making up computer system 700, may be configured to host different portions or instances of embodiments. For example, in one embodiment some elements may be implemented via one or more nodes of computer system 700 that are distinct from those nodes implementing other elements.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, processors 710 may be general-purpose or embedded processors implementing any of a variety of instruction set architectures (ISAs), such as the x86, PowerPC, SPARC, or MIPS ISAs, or any other suitable ISA. In multiprocessor systems, each of processors 710 may commonly, but not necessarily, implement the same ISA.

In some embodiments, at least one processor 710 may be a graphics processing unit. A graphics processing unit (GPU) may be considered a dedicated graphics-rendering device for a personal computer, workstation, game console or other computer system. GPUs may be very efficient at manipulating and displaying computer graphics and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods disclosed herein for layout-preserved text generation may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 720 may be configured to store program instructions and/or data accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for a layout-preserved text generation method, are shown stored within system memory 720 as program instructions 725 and data storage 735, respectively. In other embodiments, program instructions and/or data may be received, sent or stored upon different types of computer-accessible media or on similar media separate from system memory 720 or computer system 700. Generally speaking, a computer-accessible medium may include storage media or memory media such as magnetic or optical media, e.g., disk or CD/DVD-ROM coupled to computer system 700 via I/O interface 730. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 740. Program instructions may include instructions for implementing the techniques described with respect to FIGS. 3-5.

In some embodiments, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components. In addition, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., data collection server 160), such as other computer systems, or between nodes of computer system 700. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display terminals, keyboards, keypads, touchpads, scanning devices, voice or optical recognition devices, accelerometers, multi-touch screens, or any other devices suitable for entering or retrieving data by one or more computer system 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

Memory 720 may include program instructions 725, configured to implement embodiments of a layout-preserved text generation method as described herein, and data storage 735, comprising various data accessible by program instructions 725. In one embodiment, program instructions 725 may include software elements of a method illustrated in the above Figures. Data storage 735 may include data that may be used in embodiments described herein. In other embodiments, other or different software elements and/or data may be included.

Those skilled in the art will appreciate that computer system 700 is merely illustrative and is not intended to limit the scope of a layout-preserved text generation method as described herein. In particular, the computer system and devices may include any combination of hardware or software that can perform the indicated functions, including computers, network devices, internet appliances, PDAs, wireless phones, pagers, etc. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations. In some embodiments, portions of the techniques described herein (e.g., preprocessing of script and metadata may be hosted in a cloud computing infrastructure.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Various modifications and changes may be to the above technique made as would be obvious to a person skilled in the art having the benefit of this disclosure. It is intended that the invention embrace all such modifications and changes and, accordingly, the above description to be regarded in an illustrative rather than a restrictive sense. While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. Any headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

1. A method, comprising:
performing, by one or more computing devices:
executing an application and user interface (UI) action capture code, wherein the UI action capture code is configured to capture information identifying:
a sequence of user interface actions within the same view of the application interface; and
a context of the user interface actions;
during execution of the application, capturing with the UI action capture code, said information identifying the sequence and the context of user interface actions within the same view of the application interface; and
storing or transmitting one or more records comprising said information identifying the sequence and the context of user interface actions captured by the UI action capture code.

2. The method of claim 1, wherein said executing UI action capture code comprises executing one or more of code embedded within the application, tags or variables embedded within the application, a plug-in coupled to the application, a handler accessed by the application, and error handling code.

3. The method of claim 1, wherein said capturing comprises:
capturing each of a sequence of user interface actions in the same view of the application in the order they occurred; and
capturing the context of each of the sequence of user interface actions in the same view of the application interface.

4. The method of claim 3, wherein:
the user interface actions comprise one or more image processing actions; and
the context comprises one or more of screen coordinates of the user interface actions, window coordinates of the user interface actions, page coordinates of the user interface actions, a user interface view for the user interface actions, and a user interface element for the user interface actions.

5. The method of claim 3, wherein capturing the context of each of the sequence of user interface actions in the same view of the application interface further comprises capturing one or more of screen coordinates of the user interface action, window coordinates of the user interface action, page coordinates of the user interface action, a user interface view for the user interface action, and a user interface element for the user interface action.

6. The method of claim 1, wherein said storing or transmitting comprises transmitting the one or more records to a collection server.

7. The method of claim 1, wherein each of the sequence of user interface actions comprises user interface actions associated with one or more of a pasting action, a deletion action, an undo action, a zooming action, a panning action, a cropping action, and a rotation action within the same view of the application interface.

8. A method, comprising:
performing, by one or more computing devices:
receiving, from a plurality of remote computing devices, user interface action records comprising information captured during use of respective instances of an application on the plurality of remote computing devices, the information identifying:
a sequence of user interface actions within the same view of the application interface; and
a context of the user interface actions;
aggregating the information from the user interface action records for the same view of the same application; and
analyzing said aggregated information from the user interface action records for the same view of the same application according to one or more criteria.

9. The method of claim 8, wherein:
the user interface actions comprise one or more image processing actions;
said information comprises captured user interface actions and a context associated with each of the user interface actions; and
the context comprises one or more of screen coordinates of the user interface actions, window coordinates of the user interface actions, page coordinates of the user interface actions, user interface view for the user interface actions, and a user interface element for the user interface actions.

10. The method of claim 8, wherein said analyzing said aggregated information from the user interface action records comprises:
indicating one or more checkpoints;
determining the beginning and end of a chain of user interface actions comprising one or more checkpoints; and
generating a report based on chains comprising the one or more checkpoints.

11. The method of claim 10, wherein the generating the report further comprises sorting the chains according to frequency of occurrence, length of sequence, missing user actions, extra user actions or criteria associated with the checkpoint.

12. The method of claim 10, wherein said determining the beginning and end of a chain of user actions comprises:
locating the one or more checkpoints; and
identifying the sequence of user interface actions associated with the checkpoint, wherein the time stamp of the user interface action determines the sequence.

13. A system, comprising:
a processor; and
a memory having user interface (UI) action capture code stored thereon, that when executed by the processor, cause the processor to:
execute an application and UI action capture code, wherein the UI action capture code is configured to capture information identifying:
a sequence of user interface actions within the same view of the application interface; and
a context of the user interface actions;
during execution of the application, capture with the UI action capture code, said information identifying said sequence and the context of user interface actions within the same view of the application interface; and
store or transmit one or more records comprising said information identifying said sequence and the context of user interface actions captured by the UI action capture code.

14. The system of claim 13, wherein:
the context of the user interface actions comprises a timestamp for respective ones of the user interface actions; and
said sequence of user interface actions comprises user interface actions grouped according to their timestamp.

15. The system of claim 13, wherein said information comprises:
a user interface action for each of the user interface actions captured with the UI action capture code, the user interface actions comprising one or more image processing actions; and
a user interface action context for each of the user interface actions captured with the UI action capture code.

16. The system of claim 15, wherein the user interface action context comprises one or more of screen coordinates of the action, window coordinates of the action, page coordinates of the action, a user interface view for the action, and a user interface element for the action.

17. The system of claim 13, wherein said UI action capture code executable by the processor to store or transmit one or more records comprises UI action capture code executable by the processor to transmit the one or more records to a collection server.

18. A non-transitory computer readable storage medium having instructions stored thereon, that when executed by a computing device, cause the computing device to perform operations comprising:
executing an application and UI action capture code, wherein the UI action capture code is configured to capture:
a sequence of user interface actions within the same view of the application interface; and
a context of the user interface actions;
during execution of the application, capturing with the UI action capture code said sequence and the context of user interface actions within the same view of the application interface; and
storing or transmitting one or more records comprising said sequence and the context of user interface actions record by the UI action capture code.

19. The medium of claim 18, wherein said executing the UI action capture code comprises executing one or more of code embedded within the application, tags embedded within the application, a plug-in coupled to the application, a handler accessed by the application, and error handling code.

20. The medium of claim 18, wherein said capturing comprises:
capturing user interface actions in the same view of the application in the order they occurred, the user interface actions comprising one or more image processing actions; and
capturing a context for each of the user interface actions.

21. The medium of claim 20, wherein the context comprises one or more of screen coordinates of the user interface action, window coordinates of the user interface action, page coordinates of the user interface action, user interface view for the user interface action, and a user interface element for the user interface action.

22. The medium of claim 18, wherein said storing or transmitting one or more records comprises transmitting the one or more records to a collection server.

23. A non-transitory computer readable storage medium having instructions stored thereon, that when executed by a computing device, cause the computing device to perform operations comprising:
receiving, from a plurality of remote computing devices, user interface action records comprising information captured during use of respective instances of an application on the plurality of remote computing devices, the information identifying:
a sequence of user interface actions within the same view of the application interface; and
a context of the user interface actions;
aggregating the information from the user interface action records for the same view of the same application; and
analyzing said aggregated information from the user interface action records for the same view of the same application according to one or more criteria.

24. The medium of claim 23, wherein said information comprises:
captured user interface actions comprising one or more image processing actions; and
the context associated with each user interface action, wherein the context comprises one or more of screen coordinates of the user interface actions, window coordinates of the user interface actions, page coordinates of the user interface actions, user interface view for the user interface actions, and a user interface element associated with the user interface actions.

25. The medium of claim 23, wherein said analyzing said aggregated information from the user interface actions comprises:
indicating one or more checkpoints;
determining the beginning and end of a chain of user interface actions comprising one or more checkpoints; and
generating a report based on said chain comprising one or more checkpoint.

26. The medium of claim 25, wherein generating the report further comprises sorting the chains according to one or more of frequency of occurrence, length of sequence, missing user actions, extra user actions, and criteria associated with the checkpoint.

27. The medium of claim 25, wherein said determining the beginning and end of a chain of user interface actions comprises:
locating the one or more checkpoints; and
identifying the sequence of user events associated with the checkpoint, wherein the time stamp of the user interface action determines the sequence.
